(19) United States
(12) Patent Application Publication
(10) Pub. No.: US 2026/0054840 A1
(43) Pub. Date: Feb. 26, 2026

(54) CONSOLE-MOUNTED PERSONAL ELECTRONIC DEVICE HOLDER

(71) Applicant: B/E Aerospace, Inc., Winston-Salem, NC (US)

(72) Inventors: Oscar Ruiz Lara, Kirkland, WA (US); Travis J. Vaninetti, Bothell, WA (US); Peter Cansfield, Dexter, MI (US)

(21) Appl. No.: 18/811,317

(22) Filed: Aug. 21, 2024

(51) Int. Cl. B64D 11/06

(52) U.S. Cl. CPC B64D 11/0638; B64D 11/0636; B64D 11/0646

(57) ABSTRACT

A center console may include a console-mounted personal electronic device holder. A slot may be situated in a top face of the center console. The slot may be sized to receive the personal electronic device between front and back faces of the slot. The slot may be located on the forward portion of the top face and extending in a lateral direction. The slot may also be extending in a longitudinal direction. Side faces of the slot may be open or closed.

### TECHNICAL FIELD

The present disclosure generally relates to equipment fitting in aircraft, and more specifically to passenger accommodations.

### BACKGROUND

Increased Wi-Fi availability in airplanes and portability of personal electronic devices has led to an increased usage of the personal electronic devices during flight. With the increase in the usage of the personal electronics device during flight, an expectation for a means to keep the personal electronics devices within sight is expected. Solutions to keep the personal electronics devices rely on a meal table or seatback. Relying on the meal table to support the personal electronics devices clash with the meal service. Relying on the seatback to support the personal electronics devices clash with the built-in in-flight entertainment unit. Therefore, it would be advantageous to provide a device, system, and method that cures the shortcomings described above.

### SUMMARY

In some aspects, the techniques described herein relate to a center console including: one or more console armrests; a cocktail table, wherein the cocktail table is longitudinally forward of the one or more console armrests, wherein the cocktail table includes a cocktail bezel and a cocktail inset, wherein the cocktail bezel laterally and longitudinally surrounds the cocktail inset, wherein the cocktail inset is inset vertically below the cocktail bezel and the one or more console armrests; and a front trim, wherein the front trim is longitudinally forward of the cocktail table and the one or more console armrests; wherein the center console defines a lateral slot inset from a top of the center console, wherein the lateral slot is longitudinally rearward of the front trim and longitudinally forward of the cocktail inset, wherein a bottom of the lateral slot is below the cocktail inset.

In some aspects, the techniques described herein relate to a center console, wherein the lateral slot is defined by a longitudinally-rearward slot surface and a longitudinally-forward slot surface.

In some aspects, the techniques described herein relate to a center console, wherein the longitudinally-rearward slot surface and the longitudinally-forward slot surface are separated by less than 25 mm.

In some aspects, the techniques described herein relate to a center console, wherein at least one of the longitudinally-rearward slot surface or the longitudinally-forward slot surface is a flat surface.

In some aspects, the techniques described herein relate to a center console, wherein at least one of the longitudinally-rearward slot surface or the longitudinally-forward slot surface is a curved surface.

In some aspects, the techniques described herein relate to a center console, wherein at least one of: a top of the longitudinally-rearward slot surface is longitudinally aligned with of a bottom of the longitudinally-rearward slot surface; or a top of the longitudinally-forward slot surface is longitudinally aligned with a bottom of the longitudinally-forward slot surface.

In some aspects, the techniques described herein relate to a center console, wherein at least one of: a top of the longitudinally-rearward slot surface is longitudinally forward of a bottom of the longitudinally-rearward slot surface; or a top of the longitudinally-forward slot surface is longitudinally forward of a bottom of the longitudinally-forward slot surface.

In some aspects, the techniques described herein relate to a center console, wherein the lateral slot is an open-sided lateral slot, wherein the lateral slot laterally extends through an entirety of the center console.

In some aspects, the techniques described herein relate to a center console, wherein the lateral slot is a closed-sided lateral slot, wherein the lateral slot laterally extends through a portion of the center console.

In some aspects, the techniques described herein relate to a center console, including a slotted trim, wherein the slotted trim is longitudinally forward of the cocktail table and the one or more console armrests, wherein the front trim is longitudinally forward of the slotted trim, wherein the slotted trim abuts between the cocktail table and the front trim, wherein the cocktail table and the slotted trim collectively define the lateral slot.

In some aspects, the techniques described herein relate to a center console, wherein the lateral slot is disposed adjacent to the front trim.

In some aspects, the techniques described herein relate to a center console, wherein the cocktail table defines the lateral slot.

In some aspects, the techniques described herein relate to a center console, wherein the lateral slot is longitudinally offset from the front trim by a planar surface, wherein the cocktail table includes the planar surface, wherein the lateral slot is longitudinally forward of the cocktail bezel.

In some aspects, the techniques described herein relate to a center console, wherein the cocktail bezel laterally and longitudinally surrounds the lateral slot.

In some aspects, the techniques described herein relate to a center console including: one or more console armrests; a cocktail table, wherein the cocktail table is longitudinally forward of the one or more console armrests, wherein the cocktail table includes a cocktail bezel and a cocktail inset, wherein the cocktail bezel laterally and longitudinally surrounds the cocktail inset, wherein the cocktail inset is inset vertically below the cocktail bezel and the one or more console armrests; and a front trim, wherein the front trim is longitudinally forward of the cocktail table and the one or more console armrests; wherein the center console defines a longitudinal slot inset from a top of the center console, wherein the longitudinal slot is longitudinally aligned with the cocktail bezel and the cocktail inset, wherein a bottom of the longitudinal slot is below the cocktail inset.

In some aspects, the techniques described herein relate to a center console, wherein the cocktail table defines the longitudinal slot.

In some aspects, the techniques described herein relate to a center console, wherein the cocktail bezel laterally and longitudinally surrounds the longitudinal slot.

In some aspects, the techniques described herein relate to a center console, wherein the longitudinal slot is one of a pair of longitudinal slots, wherein the cocktail bezel defines the pair of longitudinal slots, wherein the cocktail inset is laterally between the pair of longitudinal slots.

In some aspects, the techniques described herein relate to a seat group including: a center console including: one or more console armrests; a cocktail table, wherein the cocktail table is longitudinally forward of the one or more console armrests, wherein the cocktail table includes a cocktail bezel and a cocktail inset, wherein the cocktail bezel laterally and longitudinally surrounds the cocktail inset, wherein the cocktail inset is inset vertically below the cocktail bezel and the one or more console armrests; and a front trim, wherein the front trim is longitudinally forward of the cocktail table and the one or more console armrests; wherein at least one of: the center console defines a lateral slot inset from a top of the center console, wherein the lateral slot is longitudinally rearward of the front trim and longitudinally forward of the cocktail inset, wherein a bottom of the lateral slot is below the cocktail inset; or wherein the center console defines a longitudinal slot inset from the top of the center console, wherein the longitudinal slot is longitudinally aligned with the cocktail bezel and the cocktail inset, wherein a bottom of the longitudinal slot is below the cocktail inset; and at least two passenger seats, wherein the center console is laterally disposed between the at least two passenger seats.

In some aspects, the techniques described herein relate to a seat group, including a pair of endcaps, wherein the pair of endcaps are disposed at opposing lateral sides of the seat group, wherein the pair of endcaps include endcap armrests and endcap tables, wherein the endcap tables are configured to stow in and deploy from the endcap armrests.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A depicts a perspective view of a seat group with a center console, in accordance with one or more embodiments of the present disclosure.

FIG. 1B depicts a partial perspective view of the seat group with the center console, in accordance with one or more embodiments of the present disclosure.

FIG. 1C depicts a partial perspective view of the center console, in accordance with one or more embodiments of the present disclosure.

FIG. 1D depicts a partial top view of the seat group with the center console, in accordance with one or more embodiments of the present disclosure.

FIG. 1E depicts a partial top view of the seat group with the center console, in accordance with one or more embodiments of the present disclosure.

FIG. 1F depicts a partial top view of the seat group with the center console, in accordance with one or more embodiments of the present disclosure.

FIG. 1G depicts a partial perspective view of the center console, in accordance with one or more embodiments of the present disclosure.

FIG. 2 depicts a partial perspective view of the center console, in accordance with one or more embodiments of the present disclosure.

FIG. 3 depicts a partial perspective view of the center console, in accordance with one or more embodiments of the present disclosure.

FIG. 4 depicts a partial perspective view of the center console, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are directed to a center console of a seat group. The center console may include a console-mounted personal electronic device holder. A slot may be situated in a top face of the center console. The slot may be sized to receive the personal electronic device between front and back faces of the slot. The slot may be located on the forward portion of the top face and extending in a lateral direction. The slot may also be extending in a longitudinal direction. Side faces of the slot may be open or closed.

U.S. Pat. No. 9,623,971B2, titled “Tray table with electronic device support for vehicles”; U.S. Pat. No. 11,603,024B2, titled “Seating module having a recessed grip and a seating arrangement including a seating module having a recessed grip”; U.S. Pat. No. 9,902,335B2, titled “Adjustable support assemblies for portable electronic devices”; U.S. Pat. No. 9,834,308B2, titled “Aircraft passenger seat center console unit”; U.S. Pat. No. 9,352,674B2, titled “Passenger seat with drop-down armrest assembly”; U.S. Pat. No. 11,046,439B2, titled “Passenger seat privacy headrest”; U.S. Pat. No. 5,195,709A, titled “Television receiver supporting structure of arm rest”; are incorporated herein by reference in the entirety.

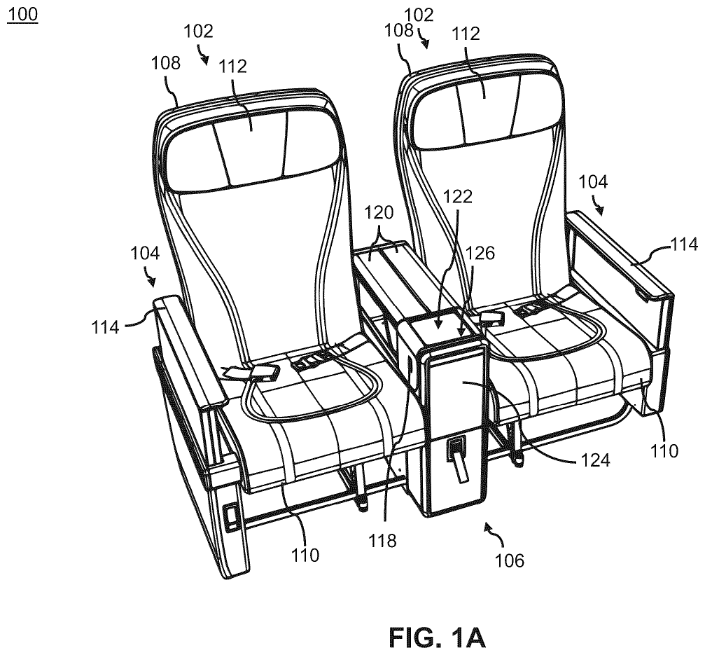

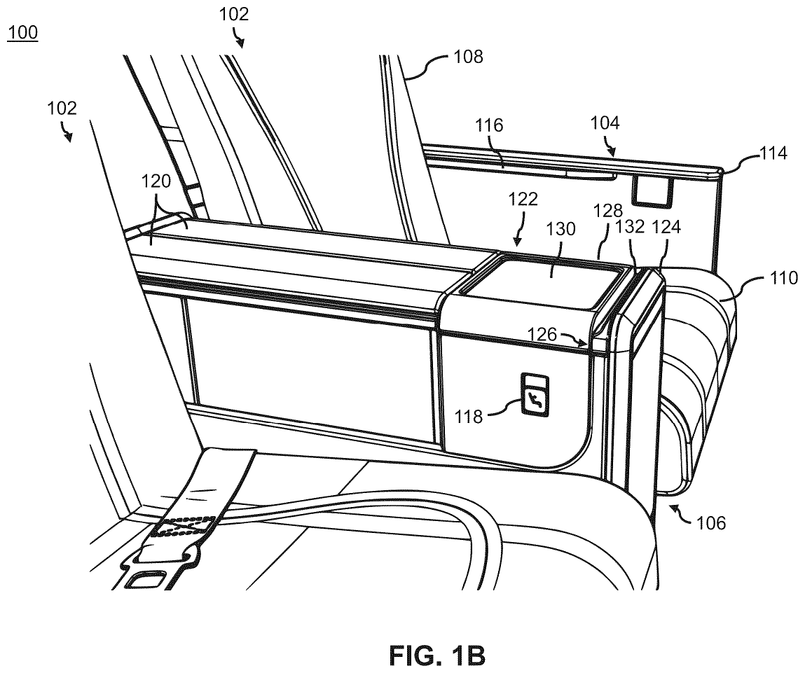

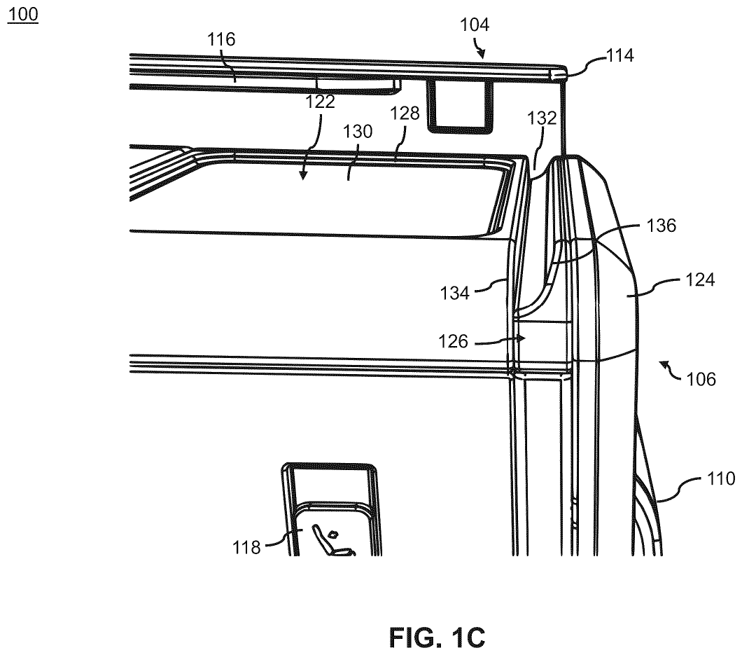

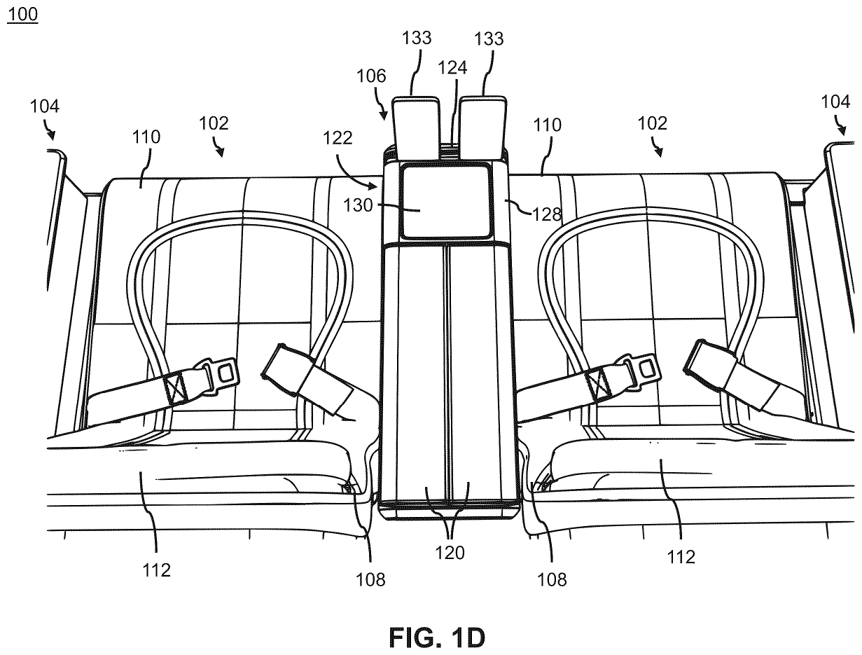

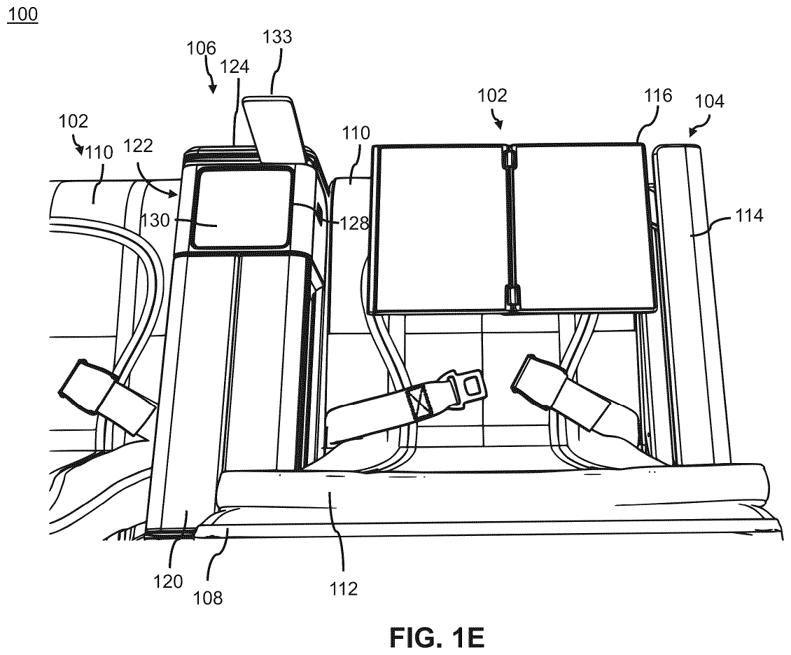

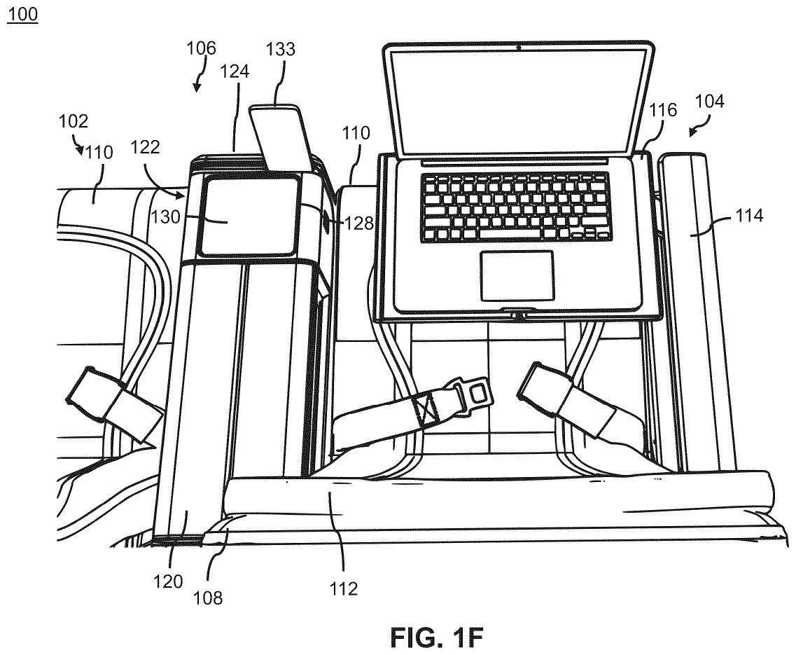

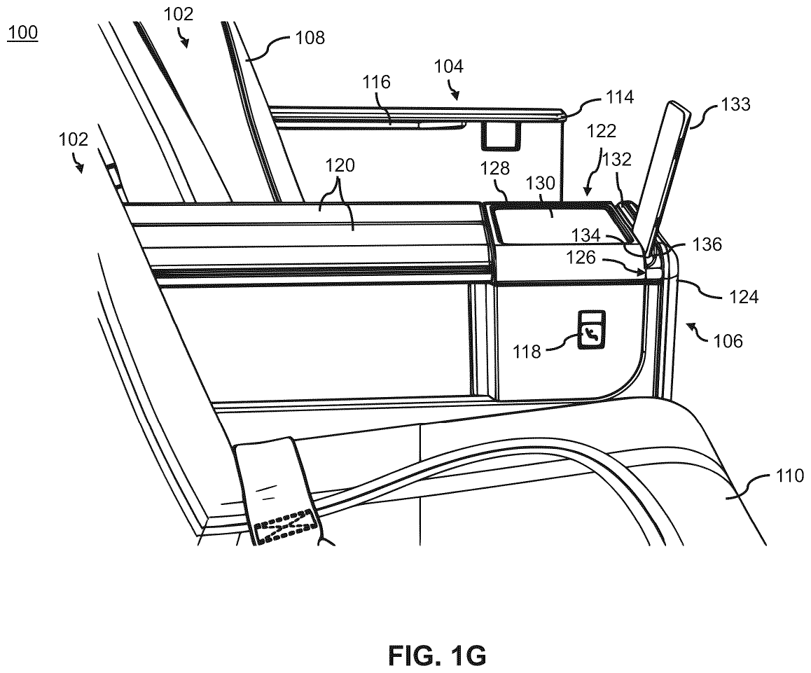

FIGS. 1A-1G depict a seat group 100, in accordance with one or more embodiments of the present disclosure. The seat group 100 may be a business class seat group, a premium economy class seat group, or the like. The seat group 100 may be coupled to a floor of an aircraft. For example, one or more components of the seat group 100 may be coupled to the floor of the aircraft by one or more floor tracks. The seat group 100 may include one or more components, such as passenger seats 102, endcaps 104, center consoles 106, and the like.

The passenger seats 102, the endcaps 104, and/or the center consoles 106 may be arranged in an abreast configuration. For example, the passenger seats 102, the endcaps 104, and/or the center consoles 106 may be laterally adjacent, longitudinally aligned, and oriented in parallel.

The seat group 100 may include two or more of the passenger seats 102. For example, the seat group 100 is depicted with two of the passenger seats 102 in a two-abreast configuration, although this is not intended to be limiting. It is contemplated that the seat group 100 may include between three of the passenger seats 102 in a three-abreast configuration or four of the passenger seats 102 in a four-abreast configuration.

The passenger seats 102 may include seatbacks 108, seat pans 110, and/or headrests 112. The seatbacks 108 and the seat pans 110 may be coupled. For example, the seatbacks 108 and the seat pans 110 may be coupled by revolute joints. The seatbacks 108 may be configured to pivot relative to the seat pans 110. For example, the seatbacks 108 may be configured to pivot between an upright position and one or more reclined positions by pivoting relative to the seat pans 110. The upright position may also be referred to as a taxi, takeoff, and land (TTOL) position. The seatbacks 108 and the headrests 112 may be coupled. For example, the seatbacks 108 and the headrests 112 may be coupled by prismatic joints. The headrests 112 may be configured to linearly translate relative to the seatbacks 108.

The endcaps 104 may be abreast with and coupled to the passenger seats 102. The endcaps 104 may be disposed at opposing lateral sides of the seat group 100. The passenger seats 102 may be laterally disposed between the endcaps 104 and the center console 106. The seat group 100 may include a pair of the endcaps 104. For example, the endcaps 104 may be abreast with and coupled to the inboard-most and outboard-most of the passenger seats 102 in the seat group 100.

The endcaps 104 may include endcap armrests 114 and/or endcap tables 116.

The endcaps 104 may be configured to raise and lower the endcap armrests 114 relative to the passenger seats 102 and/or the center console 106. For example, the endcaps 104 may be configured to raise and lower the endcap armrests 114 from a lower height in which the endcap armrests 114 are level with the seat pan 110 to an upper height in which the endcap armrests 114 are level with console armrests 120 of the center consoles 106. The endcaps 104 may be adjusted downwards to provide ingress and/or egress to the seat group 100. The endcaps 104 may be adjusted upwards to provide a comfortable height for the endcap armrests 114 and/or to deploy the endcap tables 116.

The endcap tables 116 may be referred to as trays, tray tables, shelfs, or the like. The endcap tables 116 may be configured in a stowed configuration or a deployed configuration. The endcap tables 116 may be oriented in a vertical orientation when in the stowed configuration and oriented in a horizontal orientation when in the deployed configuration. The endcap tables 116 may be stowed in and deploy from the endcap armrests 114. The endcap tables 116 may be configured between the stowed configuration and the deployed configuration when the endcap armrests 114 are in the raised position. For example, the endcap tables 116 may pivot relative to the endcap armrests 114 from the vertical orientation to the horizontal orientation. The endcap tables 116 may span a select lateral distance when in the deployed configuration. For example, the endcap tables 116 may span a portion of the distance between the endcap armrests 114 and the center consoles 106. The endcap tables 116 may include foldable portions. The foldable portions may be coupled by a revolute joint extending along a longitudinal length of the endcap tables 116. The foldable portions may be folded together when the endcap tables 116 are in the stowed configuration and folded apart when the endcap tables 116 are deployed. The foldable portions may be beneficial for reducing a vertical dimension of the endcap tables 116 in the stowed configuration. The endcap tables 116 may include any number of the foldable portions. For example, the endcap tables 116 may be bi-fold tables with two of the foldable portions.

The center consoles 106 may be abreast with and coupled to the passenger seats 102. The center consoles 106 may be referred to as side consoles. The center consoles 106 may be disposed along a length of a side of the passenger seats 102. The center consoles 106 may be laterally disposed between the passenger seats 102. The center consoles 106 may separate the passenger seats 102 from laterally adjacent of the passenger seats 102. The passenger seats 102 may be disposed at opposing lateral sides of the center consoles 106. The center consoles 106 may be abreast with and coupled to the passenger seats 102.

The seat group 100 may include one or more of the center consoles 106. For example, the seat group 100 may include one, two, or three of the center consoles 106. The number of the center consoles 106 may be based on the number of the passenger seats 102. The seat group 100 may include a set of the passenger seats 102 and the center consoles 106 which start with one of the passenger seats 102, alternating between the center consoles 106 and the passenger seats 102, and ending with one another of the passenger seats 102. For example, the seat group 100 may include one of the center consoles 106 and two of the passenger seats 102, two of the center consoles 106 and three of the passenger seats 102, or three of the center consoles 106 and four of the passenger seats 102.

The center consoles 106 may include electronic components 118, console armrests 120, a cocktail table 122, a front trim 124, slotted trim 126, or the like.

The electronic components 118 may be disposed on a lateral side of the center consoles 106. The electronic components 118 may be disposed below the console armrests 120, the cocktail table 122, the front trim 124, and/or the slotted trim 126. The electronic components 118 may be longitudinally aligned with one or more of the console armrests 120, the cocktail table 122, the front trim 124, and/or the slotted trim 126. As depicted, the electronic components 118 are longitudinally aligned with the cocktail table 122, although this is not intended to be limiting.

The electronic components 118 may include controls and associated cabling. The controls may include seat controls, video controls, audio controls, a call button, and other functions.

The console armrests 120, the cocktail table 122, the front trim 124, and/or the slotted trim 126 may be disposed at a top of the center consoles 106. The console armrests 120, the cocktail table 122, the front trim 124, and/or the slotted trim 126 may be may be disposed above the seat pans 110. The console armrests 120, the cocktail table 122, the front trim 124, and/or the slotted trim 126 may be laterally aligned. The console armrests 120, the cocktail table 122, the front trim 124, and/or the slotted trim 126 may be longitudinally arranged in a sequence. For example, the console armrests 120, the cocktail table 122, the front trim 124, and the slotted trim 126 may be longitudinal arranged in a sequence. The front trim 124 may be longitudinally forward of the slotted trim 126, the cocktail table 122, and/or the console armrests 120. The slotted trim 126 may be longitudinally forward of the cocktail table 122 and/or the console armrests 120. The cocktail table 122 may be longitudinally forward of the console armrests 120.

The console armrests 120 may be configurable between a closed position and an open position. The console armrests 120 may serve as armrests in the closed position and provide access to a storage area within the center consoles 106 in the open position. The center consoles 106 may include pairs of the console armrests 120. The pairs of the console armrests 120 may be longitudinally aligned with and disposed adjacent to each other. The pairs of the console armrests 120 may open in opposing lateral directions to each other. For example, the pairs of the console armrests 120 may open facing respective of the passenger seats 102.

The cocktail table 122 may include a cocktail bezel 128 and/or a cocktail inset 130. The cocktail bezel 128 may be at the height of the console armrests 120. For example, the cocktail bezel 128 may be at the height of the console armrests 120 when the console armrests 120 are in the closed position. The cocktail bezel 128 may laterally and/or longitudinally surround the cocktail inset 130. The cocktail inset 130 may extend from the cocktail bezel 128 by one or more edges. For example, the cocktail inset 130 may extend from the cocktail bezel 128 by one or more longitudinal fillet edges and/or lateral fillet edges. The cocktail inset 130 may be inset vertically below the cocktail bezel 128 and the console armrests 120. The cocktail inset 130 may be a horizontal surface extending laterally and longitudinally. The cocktail bezel 128 may define the cocktail inset 130 as a rounded rectangle shape. Cocktail glasses may be configured to rest on the cocktail inset 130.

The front trim 124 may be disposed at a longitudinally forward position of the center console 106. The front trim 124 may extend downwards from the top of the center console 106. For example, the front trim 124 may extend downwards from the top of the center console 106 up to a bottom of the center console 106 or to a height between the top and the bottom. The front trim 124 may cover one or more fasteners which fasten the cocktail table 122 and/or the slotted trim 126 to the center console 106. The front trim 124 may include a select finish, such as, but not limited to, a metallic finish.

The slotted trim 126 may abut between the cocktail table 122 and the front trim 124. The slotted trim 126 may be a separate component from the cocktail table 122 or formed integrally with the cocktail table 122.

The center console 106 may define a lateral slot 132. The lateral slot 132 may be defined inset from a top of the center console 106. The cocktail table 122 and/or the slotted trim 126 may define the lateral slot 132. For example, the cocktail table 122 and the slotted trim 126 may collectively define the lateral slot 132. By way of another example, the cocktail table 122 may define the lateral slot 132. The lateral slot 132 may be defined inset from a top of the cocktail table 122 and/or the slotted trim 126. The lateral slot 132 may open upwards. Opening upwards may refer to the lateral slot 132. The lateral slot 132 may be defined longitudinally rearward of the front trim 124. The lateral slot 132 may be longitudinally forward of the console armrests 120, the cocktail table 122, the cocktail bezel 128, and/or the cocktail inset 130. A top of the lateral slot 132 may be at the top of the center console 106. For example, a top of the lateral slot 132 may be vertically aligned with a top of the console armrests 120, the cocktail bezel 128, and/or the front trim 124. A bottom of the lateral slot 132 may be below the cocktail inset 130. The bottom of the lateral slot 132 and/or the cocktail inset 130 may be disposed above the seat pan 110.

The lateral slot 132 may be configured to receive personal electronic devices 133. For example, the lateral slot 132 may be configured to receive one of the personal electronic devices 133. By way of another example, the lateral slot 132 may be configured to receive two of the personal electronic devices 133 arranged laterally side-by-side. Depending on the lateral width of the lateral slot 132 and the personal electronic devices 133, more than one of the personal electronic devices 133 may be received secured in the lateral slot 132.

The personal electronic devices 133 may include a tablet computer, a cell phone, a smart phone, a handheld video game system, and other similar electronic device. The lateral slot 132 may be sized to receive the personal electronic devices 133. The lateral slot 132 may be sized to allow a bottom of the personal electronic device 133 to be placed in the lateral slot 132.

The lateral slot 132 and/or the personal electronic devices 133 may be visible from the passenger seats 102. The lateral slot 132 and/or the personal electronic devices 133 may be visible from headrest 112 of the passenger seat 102. For example, the lateral slot 132 and/or the personal electronic devices 133 may be visible from a passenger with a head resting on the headrest 112.

The lateral slot 132 may be defined by a longitudinally-rearward slot surface 134 and a longitudinally-forward slot surface 136. The longitudinally-rearward slot surface 134 and the longitudinally-forward slot surface 136 may be laterally aligned. The longitudinally-rearward slot surface 134 may be disposed longitudinally rearward of the longitudinally-forward slot surface 136. The cocktail table 122 and/or the slotted trim 126 may include the longitudinally-rearward slot surface 134 and the longitudinally-forward slot surface 136. The cocktail table 122 may include the longitudinally-rearward slot surface 134 and the slotted trim 126 may include the longitudinally-forward slot surface 136. For example, the cocktail bezel 128 of the cocktail table 122 may include the longitudinally-rearward slot surface 134.

The lateral slot 132 may be an open-sided lateral slot or a closed-sided lateral slot. The lateral slot 132 may laterally extend through the entirety of or a portion of the center console 106. The lateral slot 132 may not include lateral sides where the lateral slot 132 may extend laterally through the entirety of the center console 106 or may include lateral sides where the where the lateral slot 132 may extend laterally through the portion of the center console 106. The lateral slot 132 may not include the lateral sides for ease of cleaning. The lateral slot 132, the longitudinally-rearward slot surface 134, and/or the longitudinally-forward slot surface 136 may be defined through the axial length of or through a portion of the axial length of the center console 106.

The longitudinally-rearward slot surface 134 and/or the longitudinally-forward slot surface 136 may include a top and a bottom. The top of the longitudinally-rearward slot surface 134 and/or the top of the longitudinally-forward slot surface 136 may be at the top of the center console 106. The bottom of the longitudinally-rearward slot surface 134 and/or the bottom of the longitudinally-forward slot surface 136 may be inset below the top of the center console 106 and/or below the cocktail inset 130.

The longitudinally-rearward slot surface 134 and the longitudinally-forward slot surface 136 may be longitudinally separated by a select distance. The select distance may be selected based on a thickness of the personal electronic devices 133 and may be an amount by which the lateral slot 132 may receive the personal electronic devices 133. The personal electronic device 133 may be received between the longitudinally-rearward slot surface 134 and the longitudinally-forward slot surface 136 of the lateral slot 132. For example, the longitudinally-rearward slot surface 134 and the longitudinally-forward slot surface 136 may be longitudinally separated by less than 25 mm (e.g., about 1 inch), less than 12 mm (e.g., about ½ inch), less than 6 mm (e.g., about ¼ in) or smaller. The distance between the longitudinally-rearward slot surface 134 and the longitudinally-forward slot surface 136 may allow the personal electronic devices 133 to be received.

The longitudinally-rearward slot surface 134 and/or the longitudinally-forward slot surface 136 may be a flat surface or a curved surface. The flat surface or the curve surface may be flat or curved, respectively, along the lateral length. The curve of the curved surface may change from a shallowest angle relative to vertical at the top of the curved surface to a steepest angle relative to vertical at the bottom of the curved surface. For example, the curved surface may be roughly vertical at the top and roughly horizontal at the bottom. As depicted, the longitudinally-rearward slot surface 134 is a flat surface and the longitudinally-forward slot surface 136 is a curved surface, although this is not intended to be limiting. The longitudinally-forward slot surface 136 may be a concave surface opening upwards.

The lateral slot 132 may be oriented in a select orientation. The lateral slot 132 may hold the personal electronic devices 133 in the select orientation. The orientation may be an upright orientation or an angled orientation. The orientation may allow the personal electronic devices 133 to be visible by the passenger. The orientation of the lateral slot 132 may may be based on the longitudinal position of the top of the longitudinally-rearward slot surface 134 and the longitudinally-forward slot surface 136 relative to the bottom of respective of the longitudinally-rearward slot surface 134 and the longitudinally-forward slot surface 136. The top of the longitudinally-rearward slot surface 134 and/or the longitudinally-forward slot surface 136 may be longitudinally forward of the bottom of respective of the longitudinally-rearward slot surface 134 and the longitudinally-forward slot surface 136. Arranging the top longitudinally forward of the bottom may be beneficial to tilt the personal electronic devices 133 within the lateral slot 132 at a select viewing angle relative to vertical. Alternatively, the top of the longitudinally-rearward slot surface 134 and/or the longitudinally-forward slot surface 136 may be longitudinally aligned with the bottom of respective of the longitudinally-rearward slot surface 134 and the longitudinally-forward slot surface 136. The longitudinally-rearward slot surface 134 and the longitudinally-forward slot surface 136 may be vertical surfaces where the top is longitudinally aligned with the bottom. As depicted, the top of the longitudinally-rearward slot surface 134 is longitudinally aligned with the bottom of longitudinally-rearward slot surface 134 and the top of the longitudinally-forward slot surface 136 is longitudinally forward of the bottom of the longitudinally-forward slot surface 136, although this is not intended to be limiting.

The lateral slot 132, the longitudinally-rearward slot surface 134, and/or the longitudinally-forward slot surface 136 may be made of a select material. For example, the lateral slot 132, the longitudinally-rearward slot surface 134, and/or the longitudinally-forward slot surface 136 may be made of a hard plastic material.

The lateral slot 132 may be disposed at one or more positions relative to the front trim 124. The lateral slot 132 may be disposed adjacent to the front trim 124. Disposing the lateral slot 132 adjacent to the front trim 124 may maximize the area of the cocktail inset 130.

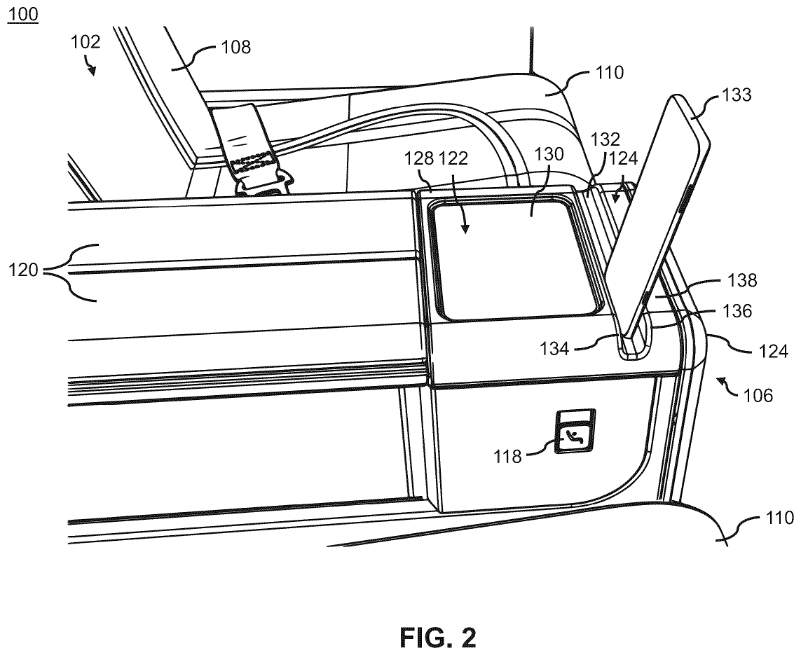

FIG. 2 depicts the seat group 100, in accordance with one or more embodiments of the present disclosure. The cocktail table 122 and/or the slotted trim 126 may be integrally formed. The lateral slot 132 may be defined by the cocktail table 122. The cocktail table 122 may include the longitudinally-rearward slot surface 134 and the longitudinally-forward slot surface 136.

Although the lateral slot 132 is described as disposed adjacent to the front trim 124, this is not intended as a limitation of the present disclosure. The lateral slot 132 may be longitudinally separated from the front trim 124 by a planar surface 138. The cocktail table 122 may include the planar surface 138. The planar surface 138 may define the longitudinal distance between the front trim 124 and the lateral slot 132. Offsetting the lateral slot 132 from the front trim 124 by the planar surface 138 may reduce the area of the cocktail inset 130. Offsetting the lateral slot 132 from the front trim 124 may also provide additional structural location in which to couple the front trim 124 and the cocktail bezel 128 via fasteners.

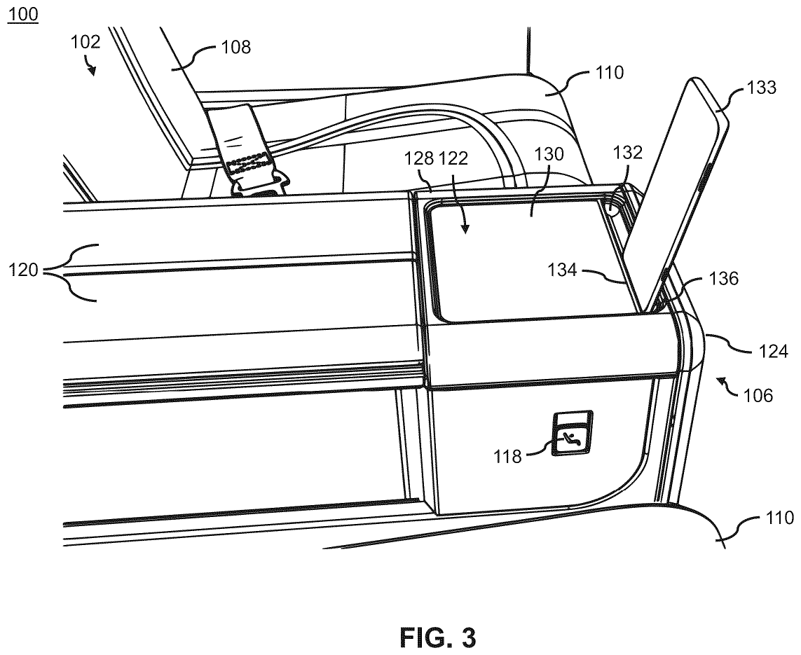

FIG. 3 depicts the seat group 100, in accordance with one or more embodiments of the present disclosure. Although the lateral slot 132 is described as disposed longitudinally forward of the cocktail bezel 128, this is not intended as a limitation of the present disclosure. The lateral slot 132 may be disposed longitudinally and laterally within the cocktail bezel 128. The cocktail bezel 128 may laterally and longitudinally surround the lateral slot 132. A front portion of the cocktail bezel 128 may be disposed longitudinally forward of the lateral slot 132, side portions of the cocktail bezel 128 may be disposed laterally adjacent to the lateral slot 132, and a rear portion of the cocktail bezel 128 may be disposed longitudinally rearward of the lateral slot 132. The cocktail bezel 128 may define the longitudinally-rearward slot surface 134 and/or the longitudinally-forward slot surface 136. The cocktail inset 130 may be longitudinally disposed rearward of and laterally aligned with the lateral slot 132, the longitudinally-rearward slot surface 134, and/or the longitudinally-forward slot surface 136. The lateral slot 132 may be a closed-sided lateral slot which extends laterally through the portion of the center console 106. Lateral sides of the lateral slot 132 may be defined by lateral sides of the cocktail bezel 128.

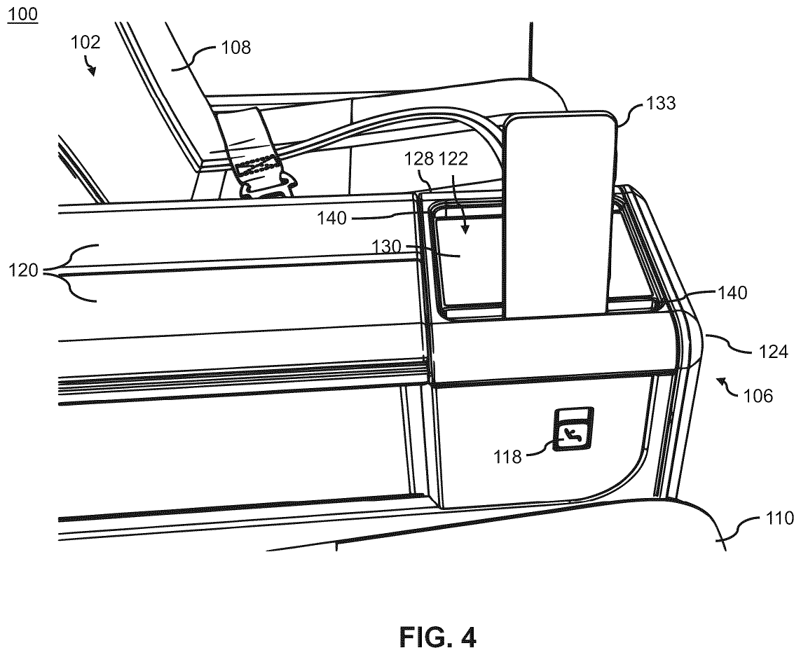

FIG. 4 depicts the seat group 100, in accordance with one or more embodiments of the present disclosure. Although the center console 106 is described as defining the lateral slot 132, this is not intended as a limitation of the present disclosure. The center console 106 may define a longitudinal slot 140. The longitudinal slot 140 may be defined inset from a top of the center console 106. The cocktail table 122 and/or the slotted trim 126 may define the longitudinal slot 140. For example, the cocktail bezel 128 may define the longitudinal slot 140. The longitudinal slot 140 may be defined inset from a top of the cocktail table 122 and/or the slotted trim 126. The longitudinal slot 140 may open upwards. The longitudinal slot 140 may be defined longitudinally aligned with the cocktail bezel 128 and/or the cocktail inset 130. A top of the longitudinal slot 140 may be at the top of the center console 106. A bottom of the longitudinal slot 140 may be below the cocktail inset 130. The longitudinal slot 140 may be configured to receive the personal electronic devices 133. The longitudinal slot 140 may include a width matching the width of the lateral slot 132 by which the longitudinal slot 140 may receive the personal electronic devices 133. For example, the longitudinal slot 140 may include a width of less than 25 mm. The longitudinal slot 140 may hold the personal electronic devices 133 in a select orientation. The orientation may be an upright orientation or an angled orientation. The longitudinal slot 140 may be a closed-sided longitudinal slot which may longitudinally extend through a portion of the center console 106. The longitudinal slot 140 may be disposed longitudinally within the cocktail bezel 128. The cocktail bezel 128 may laterally and longitudinally surrounds the longitudinal slot 140. The longitudinal slot 140 may be one of a pair of longitudinal slots 140. The cocktail bezel 128 may define pairs of the longitudinal slot 140. The cocktail inset 130 may be laterally between the pairs of the longitudinal slot 140. A front portion of the cocktail bezel 128 may be disposed longitudinally forward of the lateral slot 132, side portions of the cocktail bezel 128 may be define the longitudinal length of the lateral slot 132, and a rear portion of the cocktail bezel 128 may be disposed longitudinally rearward of the lateral slot 132. The longitudinal slot 140 may not extend longitudinally through the center console 106. The longitudinal slot 140 may extend longitudinally through a portion of the center console 106. Longitudinal ends of the lateral slot 132 may be defined by a portion of the front and a portion off the rear of the cocktail bezel 128.

Referring generally again to the figures. The center console 106 may define at least one of the lateral slot 132 or the longitudinal slot 140. The lateral slot 132 and/or the longitudinal slot 140 may be console-mounted personal electronic device holders. The lateral slot 132 and/or the longitudinal slot 140 may secure the personal electronic devices 133 in a highly visible area. Receiving the personal electronic devices 133 within the lateral slot 132 and/or the longitudinal slot 140 may not interfere with use of the endcap tables 116. The lateral slot 132 and/or the longitudinal slot 140 in the center console 106 may avoid having to use the personal electronic devices 133 on the endcap tables 116. The lateral slot 132 and/or the longitudinal slot 140 in the center console 106 may also free other device holders such as seatback mounted holders or the endcap tables 116 to hold larger devices, enabling multi-screen setups. For example, the endcap tables 116 may be used to support additional of the personal electronic devices 133, meals, or the like. By way of another example, the personal electronic devices 133 may be configured in the stowed configuration while the personal electronic devices 133 are received within the lateral slot 132 and/or the longitudinal slot 140.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A center console comprising:
one or more console armrests;
a cocktail table, wherein the cocktail table is longitudinally forward of the one or more console armrests, wherein the cocktail table comprises a cocktail bezel and a cocktail inset, wherein the cocktail bezel laterally and longitudinally surrounds the cocktail inset, wherein the cocktail inset is inset vertically below the cocktail bezel and the one or more console armrests; and
a front trim, wherein the front trim is longitudinally forward of the cocktail table and the one or more console armrests; wherein the center console defines a lateral slot inset from a top of the center console, wherein the lateral slot is longitudinally rearward of the front trim and longitudinally forward of the cocktail inset, wherein a bottom of the lateral slot is below the cocktail inset.

2. The center console of claim 1, wherein the lateral slot is defined by a longitudinally-rearward slot surface and a longitudinally-forward slot surface.

3. The center console of claim 2, wherein the longitudinally-rearward slot surface and the longitudinally-forward slot surface are separated by less than 25 mm.

4. The center console of claim 2, wherein at least one of the longitudinally-rearward slot surface or the longitudinally-forward slot surface is a flat surface.

5. The center console of claim 2, wherein at least one of the longitudinally-rearward slot surface or the longitudinally-forward slot surface is a curved surface.

6. The center console of claim 2, wherein at least one of:
a top of the longitudinally-rearward slot surface is longitudinally aligned with of a bottom of the longitudinally-rearward slot surface; or
a top of the longitudinally-forward slot surface is longitudinally aligned with a bottom of the longitudinally-forward slot surface.

7. The center console of claim 2, wherein at least one of:
a top of the longitudinally-rearward slot surface is longitudinally forward of a bottom of the longitudinally-rearward slot surface; or
a top of the longitudinally-forward slot surface is longitudinally forward of a bottom of the longitudinally-forward slot surface.

8. The center console of claim 1, wherein the lateral slot is an open-sided lateral slot, wherein the lateral slot laterally extends through an entirety of the center console.

9. The center console of claim 1, wherein the lateral slot is a closed-sided lateral slot, wherein the lateral slot laterally extends through a portion of the center console.

10. The center console of claim 1, comprising a slotted trim, wherein the slotted trim is longitudinally forward of the cocktail table and the one or more console armrests, wherein the front trim is longitudinally forward of the slotted trim, wherein the slotted trim abuts between the cocktail table and the front trim, wherein the cocktail table and the slotted trim collectively define the lateral slot.

11. The center console of claim 10, wherein the lateral slot is disposed adjacent to the front trim.

12. The center console of claim 1, wherein the cocktail table defines the lateral slot.

13. The center console of claim 12, wherein the lateral slot is longitudinally offset from the front trim by a planar surface, wherein the cocktail table comprises the planar surface, wherein the lateral slot is longitudinally forward of the cocktail bezel.

14. The center console of claim 12, wherein the cocktail bezel laterally and longitudinally surrounds the lateral slot.

15. A center console comprising:
one or more console armrests;
a cocktail table, wherein the cocktail table is longitudinally forward of the one or more console armrests, wherein the cocktail table comprises a cocktail bezel and a cocktail inset, wherein the cocktail bezel laterally and longitudinally surrounds the cocktail inset, wherein the cocktail inset is inset vertically below the cocktail bezel and the one or more console armrests; and
a front trim, wherein the front trim is longitudinally forward of the cocktail table and the one or more console armrests;
wherein the center console defines a longitudinal slot inset from a top of the center console, wherein the longitudinal slot is longitudinally aligned with the cocktail bezel and the cocktail inset, wherein a bottom of the longitudinal slot is below the cocktail inset.

16. The center console of claim 15, wherein the cocktail table defines the longitudinal slot.

17. The center console of claim 16, wherein the cocktail bezel laterally and longitudinally surrounds the longitudinal slot.

18. The center console of claim 16, wherein the longitudinal slot is one of a pair of longitudinal slots, wherein the cocktail bezel defines the pair of longitudinal slots, wherein the cocktail inset is laterally between the pair of longitudinal slots.

19. A seat group comprising:
a center console comprising:
one or more console armrests;
a cocktail table, wherein the cocktail table is longitudinally forward of the one or more console armrests, wherein the cocktail table comprises a cocktail bezel and a cocktail inset, wherein the cocktail bezel laterally and longitudinally surrounds the cocktail inset, wherein the cocktail inset is inset vertically below the cocktail bezel and the one or more console armrests; and
a front trim, wherein the front trim is longitudinally forward of the cocktail table and the one or more console armrests;
wherein at least one of:
the center console defines a lateral slot inset from a top of the center console, wherein the lateral slot is longitudinally rearward of the front trim and longitudinally forward of the cocktail inset, wherein a bottom of the lateral slot is below the cocktail inset; or
wherein the center console defines a longitudinal slot inset from the top of the center console, wherein the longitudinal slot is longitudinally aligned with the cocktail bezel and the cocktail inset, wherein a bottom of the longitudinal slot is below the cocktail inset; and
at least two passenger seats, wherein the center console is laterally disposed between the at least two passenger seats.

20. The seat group of claim 19, comprising a pair of endcaps, wherein the pair of endcaps are disposed at opposing lateral sides of the seat group, wherein the pair of endcaps comprise endcap armrests and endcap tables, wherein the endcap tables are configured to stow in and deploy from the endcap armrests.
